(19) United States
(12) Patent Application Publication
(10) Pub. No.: US 2008/0287643 A1
(43) Pub. Date: Nov. 20, 2008

(54) Polyamides Formed From Metaxylylenediamine and Adipic and Having an Amino End Group Content of Less Than 15 Mmol/Kg

(75) Inventors: Joachim Strauch, Mannheim (DE); Jurgen Deininger, Oftersheim (DE); Bernhard Rosenau, Neustadt (DE); Thomas Liese-Sauer, Hassloch (DE); Rolf-Egbert Grutzner, Obrigheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, LUDWIGSHAFEN (DE)

(21) Appl. No.: 12/090,979

(22) PCT Filed: Oct. 17, 2006
(86) PCT No.: PCT/EP2006/067471

§ 371 Date: Aug. 5, 2008

(30) Foreign Application Priority Data
Oct. 25, 2005 (DE) 10 2005 051 400.6

(51) Int. Cl. C08G 69/26

(52) U.S. Cl. 528/347

(57) ABSTRACT

The present invention relates to novel and improved polyamides composed of meta-xylylenediamine and having an amino end group content of less than 15 mmol/kg. Also found have been processes for preparing these polyamides composed of meta-xylylenediamine and adipic acid and having an amino end group content of less than 15 mmol/kg, which comprises reacting salt solutions of adipic acid and m-xylylenediamine at temperatures of from 80 to 300° C. and a pressure of from 1 to 20 bar with removal of water.

The present invention relates to polyamides composed of meta-xylylenediamine and adipic acid and having an amino end group content of less than 15 mmol/kg, and to processes for their preparation.

U.S. Pat. No. 2,998,463 discloses a process for suppressing the degradation of amino end groups by formation of xylylenetriamine. The reduction in the amino end group degradation is achieved by a batchwise process with a two-stage temperature/pressure profile in aqueous salt solution. In the mixture, a slight excess (0.6 mol %) of adipic acid is used. The stability of the poly(m-xylyleneadipamide)s thus prepared in the melt or during solid-phase condensations leaves something to be desired.

WO-A-00/22043 describes the preparation of a low molecular weight poly(m-xylylene-adipamide) with acid end group excess as a blend component for polyethylene terephthalate. The poly(m-xylyleneadipamide) is prepared in an ambient-pressure batchwise process which is unsuitable for industrial production. In addition, the poly(m-xylyleneadipamide) has a very high residual monomer content of adipic acid.

U.S. Pat. No. 6,303,741 discloses the solid-phase condensation of poly(m-xylylene-adipamides) in a melt process. The acid end group excesses after the melt polymerization are defined as follows: 8≦CEG−AEG≦82; for the relative viscosity: 1.83≦RV≦2.28 (after the melt polymerization).

JP-A-2003/165838 and JP-A-2003/252986 relate to two-stage process for preparing polymers based on a starting mixture composed of the monomers and less than 20% by weight of water. Poly(m-xylyleneadipamide)s with the following end group ratio are obtained: CEG/AEG≧1.2. The final end group ratio is controlled at the end of the process by addition of regulator, more specifically acid anhydrides. The relative viscosity is 1.8≦RV≦3.6.

It is an object of the present invention to remedy the aforementioned disadvantages.

We have found that this object is achieved by novel and improved polyamides composed of meta-xylylenediamine and adipic acid and having an amino end group content of less than 15 mmol/kg. We have also found processes for preparing these polyamides composed of meta-xylylenediamine and adipic acid, which comprises salt solutions of adipic acid and m-xylenediamine being reacted at temperatures of from 80 to 300° C. and a pressure of from 1 to 20 bar with removal of water.

The inventive polyamide compositions feature
a) a low content of triamine (<0.30% by weight, preferably <0.15% by weight),
b) a preparation process optimized to minimal triamine contents (continuously and batchwise) which is based on a from 50 to 70% by weight aqueous salt solution and is industrially implementable,
c) a minimal amino end group content (AEG<15) and a relative viscosity in the range from 1.55 to 2.0,
d) a high melt stability (η₆₀ₘᵢₙ/η₅ₘᵢₙ<1.5, η₆₀ₘᵢₙ=melt viscosity after 60 min at 280° C. in a rheometer, η₅ₘᵢₙ=melt viscosity after 60 min at 280° C. in a rheometer) and a high stability during solid-phase condensations (ΔRV<0.4 after 14 h at 230° C.),
e) a high dispersibility in polyethylene terephthalates. The dispersibility of the polyamides in the polyethylene terephthalate matrix directly affects the haze of the containers or films produced from the PET/polyamide mixtures. The finer the dispersion of the polyamide, the lower the haze. For instance, monolayer bottles composed of mixtures of the inventive polyamides and polyethylene terephthalates which have been modified by isophthalic acid and alkali metal salts of sulfoisophthalic acid have surprisingly low haze values.

The process according to the invention can be performed as follows:

Salt solutions, preferably aqueous salt solutions, of adipic acid and m-xylylenediamine [1,3-bis-(aminomethyl)benzene] can be reacted batchwise or preferably continuously at temperatures of from 80 to 300° C., preferably from 100 to 280° C., more preferably from 120 to 270° C., and a pressure of from 1 to 20 bar, preferably from 1.5 to 10 bar, more preferably from 2 to 7 bar, in particular from 3 to 6 bar, in pressure vessels with removal of water.

In the batchwise method, the reaction is effected generally in one or more, i.e. from 1 to 6, preferably from 2 to 4, more preferably 2 or 3, in particular 2 pressure stages.

In the embodiment in one pressure stage, the mixture of adipic acid and m-xylylene-diamine may be concentrated up to from 80 to 100% by weight, preferably from 90 to 100% by weight, more preferably from 95 to 100% by weight, by removal of water at a temperature of from 80 to 300° C., preferably from 150 to 280° C.

The embodiment with 2 pressure stages can be effected such that, in the first pressure stage, which is generally carried out at a pressure of from 1 to 3 bar, and the mixture of adipic acid and m-xylylenediamine is concentrated up to from 80 to 98% by weight, preferably from 85 to 96% by weight, more preferably from 90 to 95% by weight, by removal of water at a temperature of from 80 to 150° C., preferably from 100 to 140° C. In the second pressure stage, which is generally carried out at a pressure of from 1 to 3 bar, concentration can be effected up to from 95 to 100% by weight, preferably from 98 to 100% by weight, more preferably from m 99 to 100% by weight, by removal of water at a temperature of from 120 to 300° C., preferably from 150 to 280° C. and a pressure of from 3.5 to 10 bar, preferably 4 to 6 bar.

A particularly preferred embodiment of the batchwise reaction consists in working in a stirred steel autoclave at a pressure of from 2 to 10 bar, preferably from 3 to 8 bar and more preferably from 4 to 6 bar. In this embodiment, a two-stage pressure profile is used. The mixture is heated first to internal temperature 120° C. and, from a pressure of 2 bar, sufficient water is distilled off that an approx. 90% by weight mixture is present. In the course of this, the internal temperature rises to from 155 to 165° C. Subsequently, the mixture is heated to the target pressure, particular preference being given to 4 bar. The temperature rises to from 170 to 180° C. at 4 bar. At 4 bar, the remaining water is distilled off, in the course of which the temperature rises to from 245 to 250° C. The tank is then decompressed to atmospheric pressure. If the relative viscosity which is needed for the subsequent granulation has not yet been attained, a postcondensation time in the melt with nitrogen purging follows at from 245 to 265° C. with a variable duration of from 5 to 30 min. After the postcondensation, the polyamide is discharged through a water bath and the extrudate is granulated. An internal temperature of 265° C. is not exceeded throughout the entire condensation process. As a result of the gentle temperature/pressure profile used, the loss of meta-xylylenediamine during the polymerization process is below 0.15% by weight. A correction of the end group ratio in the end phase of the process by addition of regulators, as already described in JP-A-2003/165838 and JP-A-2003/252986, is therefore unnecessary. The relative viscosity of the inventive polyamide compositions, measured as 1% solution (1 g/100 ml) in 96% by weight H₂SO₄ at 23° C., is in the range from 1.45 to 1.70.

In the preferred continuous method, the reaction can be carried out in such a way that salt solutions of adipic acid and m-xylylenediamine are heated at a temperature of from 210 to 330° C., preferably from 250 to 300° C., more preferably from 260 to 280° C., then the prepolymer is preferably separated batchwise, preferably continuously, from reactant and water (referred to here as steam), the meta-xylylenediamine removed, if appropriate or preferably, is generally returned quantitatively. Finally, the prepolymer can be polycondensed under a pressure of from 1 to 20 bar, preferably from 1.5 to 15 bar, more preferably from 2 to 10 bar, in particular from 4 to 6 bar, and a temperature of from 230 to 330° C., preferably from 250 to 300° C., more preferably from 260 to 280° C.

A particular embodiment consists in heating the salt solution under a pressure of from 2 to 10 bar, preferably from 4 to 6 bar, within a residence time of 60 seconds, the degree of reaction being at least 95% and the water content of the prepolymer being at most 7% by weight on exit from the evaporator zone. This is achieved by the salt solution being passed through an evaporation zone which is tubular or designed with tubular and slot-like sections and is filled with random packings, and in which a biphasic flow already forms as a result of heating and water evaporation and the majority of the water of dissolution is already driven into the gas phase. These short residence times generally substantially suppress the formation of triamines. The aqueous solutions used generally have a monomer content of from 30 to 70% by weight, in particular from 45 to 65% by weight.

In the particularly preferred embodiment, the aqueous salt solution may advantageously be passed with a temperature of from 50 to 100° C. batchwise, preferably continuously, into an evaporator zone where the aqueous salt solution can be heated to a temperature of from 250 to 300° C., preferably from 260 to 280° C., under a pressure of from 2 to 10 bar, preferably from 4 to 6 bar. The evaporation zone consists of one or more tube(s) filled with annular random packings and having an l/d ratio of from 100:1 to 200:1, preferably from 120:1 to 180:1, more preferably from 140:1 to 160:1, which has throughputs of from 1 to 10 kg of polymer per hour per tube, preferably from 3 to 7 kg of polymer per hour per tube, more preferably from 4 to 6 kg of polymer per hour per tube passed through it. The tubes are preferably passed through with a short residence time. The conversion on exit from the evaporator zone is generally from 80 to 100%, preferably from 90 to 99.5%, more preferably from 95 to 99%, in particular from 96 to 98%, and the water content is generally in the range from 0.01 to 10% by weight, preferably from 0.1 to 5% by weight, more preferably from 1 to 3% by weight, depending on the pressure established. The evaporator zone is advantageously configured as a tube bundle. Particularly useful tube bundles have been found to be those in which the cross section of the individual tubes has a periodically repeating tubular and slot-like design. It has also been found to be advantageous to pass the mixture of prepolymers and steam, before the separation of the phases, immediately after the evaporator zone, through a tubular mass transfer zone which is provided with internals. In this case, the temperatures and pressure conditions employed in the evaporator zone are observed. The internals, for example random packings such as Raschig rings, metal rings or especially random packings made of wire mesh, give rise to a large surface area. As a result, the phases, i.e. prepolymer and steam, come into intimate contact. This has the effect that the amount of meta-xylylenediamine released with steam is reduced considerably.

The biphasic mixture of steam and prepolymer leaving the evaporator zone or mass transfer zone is separated. The separation generally proceeds by itself owing to the physical properties in a vessel, the lower part of the vessel advantageously being designed as the polymerization zone. The vapors released consist essentially of steam and traces of meta-xylylenediamine which has been released in the course of evaporation of the water. In general, only an extremely small amount of meta-xylylene-diamine is present in the gas phase (<0.1% by weight based on the polymer throughput). These vapors can be passed into a column and rectified in order to recover the meta-xylylenediamine. Suitable columns are, for example, columns with random packings, bubble-cap tray columns or sieve tray columns having from 5 to 15 theoretical plates. The column is appropriately operated under identical pressure conditions to the evaporator zone. Advantageously, the rectified meta-xylylenediamine can be fed to the downstream polymerization zone.

The resulting prepolymer which, in accordance with its degree of reaction, consists essentially of low molecular weight polyamide and any residual amounts of unconverted salts and generally has a relative viscosity (measured as solution with a concentration of 1 g per 100 g of solvent in 96% sulfuric acid) of less than or equal to 1.2 is passed into a polymerization zone. In the polymerization zone, the melt obtained can generally be polycondensed at a temperature of from 245 to 285° C., in particular from 255 to 275° C., and under a pressure of from 2 to 10 bar, in particular from 4 to 6 bar.

Advantageously, in a preferred procedure, the polyamide thus obtained can be passed in molten form through a discharge zone with simultaneous removal of the residual water present in the melt. Suitable discharge zones are, for example, venting extruders. The melt thus freed of water can then be worked up by processes known per se, for example by underwater sphere pelletization, underwater strand pelletization or strand pelletization. The resulting pellet can be subjected to an extraction and this can be effected either continuously or batchwise. Suitable extractants include water, C₁- to C₈-alkanols such as ethanol and methanol, preferably water. The extracted polyamide can be subjected to a solid phase condensation in a further step. This can be carried out either in vacuum or under inert gas such as nitrogen or argon, preferably nitrogen. The temperature can be varied within a wide range; it is generally between 120 to 230° C., preferably between 130 to 210° C. and more preferably between 140 to 190° C. In a preferred procedure, the polyamide may be granulated with an underwater sphere granulation.

The relative viscosity of the inventive polyamides, measured in 1% solution (1 g/100 ml) in 96% by weight sulfuric acid at 25° C. is, after leaving the discharge extruder in the range from 1.45 to 1.55.

To establish the relative target viscosities, the resulting pellet can finally, in solid phase, be adjusted batchwise, preferably in tumblers, or continuously, preferably in annealing towers, to a relative viscosity in the range from 1.55 to 2.0 at temperatures between 140 and 160° C. After the preparation process, the inventive polyamide compositions have relative viscosities in the range of 1.55 and 2.0, preferably of from 1.60 to 1.9 and more preferably of from 1.65 to 1.75. After annealing, the value of the residual moisture content in the pellet is generally below 250 ppm.

The molar ratio of adipic acid to meta-xylylenediamine may be varied, and is generally from 1.5:1 to 1.001:1, preferably from 1.2:1 to 1.005:1, more preferably from 1.1:1 to 1.007:1, in particular from 1.05:1 to 1.01:1.

The residual monomer content of adipic acid in the inventive unextracted polyamides is up to 600 ppm. With regard to the possible use in packaging of foods, the pellet of the polyamides can be subjected to an extraction. This effectively lowers the content of residual monomers.

After the extraction, the residual monomer content of adipic acid in the polyamide is generally up to 500 ppm, for example from 1 to 400 ppm, preferably from 1 to 200 ppm, more preferably between 1 to 150 ppm. The residual monomer content of meta-xylylenediamine is generally below 10 ppm.

Suitable polyamides are generally all polyamides which are formed from 50 to 100% by weight, preferably from 70 to 100% by weight, more preferably from 85 to 100% by weight of units formed from meta-xylylenediamine and adipic acid, and also from 0 to 50% by weight, preferably from 0 to 30% by weight, more preferably from 0 to 15% by weight of the corresponding other polyamide units and/or chain regulators if appropriate and/or stabilizers if appropriate.

Suitable comonomers of meta-xylylenediamine are, for example, aliphatic, aromatic or arylaliphatic diamines such as ethylenediamine, butylenediamine, pentamethylene-diamine, hexamethylenediamine, cyclohexanediamine, octamethylenediamine, bis(4,4-aminocyclohexyl)methane, bis(4,4-amino-3,3-methylcyclohexyl)methane, bis(amino)-cyclohexane, para-phenylenediamine, ortho-xylylenediamine and para-xylylene-diamine.

Suitable comonomers of adipic acid are, for example, aliphatic, aromatic or arylaliphatic dicarboxylic acids such as terephthalic acid, sulfoisophthalic acid and salts thereof, naphthalene-2,6-dicarboxylic acid, cyclohexanedicarboxylic acid, succinic acid, glutaric acid, azelaic acid and sebacic acid.

Suitable chain regulators are, for example, monofunctional regulators such as triacetonediamine compounds (see WO-A 95/28443), monocarboxylic acids such as acetic acid, propionic acid and benzoic acid, and bases such as (mono)amines, for example hexylamine or benzylamine.

In order to improve the properties of the inventive polyamides, all known additives, for example nucleating agents, dyes, color pigments, flow improvers, UV-absorbing substances, matting agents, oxygen scavengers, inorganic or organic or impact-modified fillers are suitable for modification.

Suitable stabilizers are literature-disclosed (Plastics Additives Handbook, 5th Edition, pages 97-136; 2001) sterically hindered phenols, phosphorus compounds, for example the phosphites and hypophosphites, and mixtures of these two stabilizer classes.

The polyamides comprise generally from 0 to 0.5% by weight, preferably from 0.001 to 0.1% by weight, more preferably from 0.01 to 0.05% by weight of stabilizers.

In a preferred form, the inventive polyamide compositions comprise from 0 to 0.05% by weight, more preferably from 0 to 0.03% by weight of hypophosphite.

In a particularly preferred embodiment, the content of secondary triamine in the polyamide is less than or equal to 0.3% by weight, preferably less than or equal to 0.15% by weight. This content can be determined, for example, indirectly via the so-called “triamine content” [(xylylenetriamine) content→see structural formula below] (see examples).

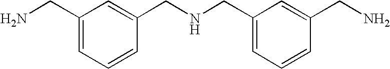

The low amino end group contents can be controlled via the stoichiometry of the two monomers in preparing the starting salt solution. In the inventive polyamide compositions, adipic acid excesses in the range of from 60 mmol/kg to 150 mmol/kg, preferably from 70 mmol/kg to 130 mmol/kg, more preferably from 80 mmol/kg to 110 mmol/kg may.

The inventive polyamides composed of meta-xylylenediamine and adipic acid are suitable for production or as a starting material, especially in conjunction with polyesters, for the production of moldings, tubes, profiles, preforms, containers, dishes, fibers, film, bottles and foams of all types, for example by extruding, injection-molding, calendering, blow-molding, compressing, sintering or other customary processes of thermoplastics processing.

Suitable polyesters are, for example, polybutylene terephthalates, polyethylene naphthalates, polytrimethylene terephthalate and polyethylene terephthalate, and also the corresponding copolyesters.

A further property of the inventive polyamide compositions is the surprisingly good dispersibility in a polyethylene terephthalate matrix. Particularly good results can be achieved in polyethylene terephthalates which have been modified by isophthalic acid and by alkali metal salts of sulfoisophthalic acid.

The preferred use of the inventive polyamides is in the preparation of blend mixtures with polyethylene terephthalate which have been modified by isophthalic acid and by alkali metal salts of sulfoisophthalic acid. These are particularly suitable for producing transparent, colorless containers and injection moldings, especially preforms and bottles for the drinks industry. In this preferred embodiment, 0.01 and 15% by weight, preferably from 0.02 to 10% by weight, more preferably from 0.03 to 7% by weight of polyamide are present in the polyethylene terephthalate.

A general process consists in preparing granule mixtures from the modified polyethylene terephthalates and the inventive polyamides. These “pepper/salt” mixtures can be directly converted on the injection molding machine to moldings and preforms.

The use of the inventive polyamides in conjunction with the polyethylene terephthalates is not only restricted to the preparation of granule mixtures.

A further advantage of the inventive polyamides lies in the high stability in relation to the molecular weight and the color. As a result, these polyamide compositions survive further processing operations in the presence of polyethylene terephthalate without forming gels and are notable for high stability in the melt and in solid phase condensation processes. In this case, the polyethylene terephthalates have been modified by isophthalic acid and by alkali metal salts of sulfoisophthalic acid.

The further processing operations in the melt are particularly extrusion processes for preparing polyamide/polyethylene terephthalate blend granules with dispersed polyamide in a polyethylene terephthalate matrix.

One preferred use of the inventive polyamides in conjunction with polyethylene terephthalates is the preparation of two-component or multicomponent granules. This bicomponent pellet may, for example, have a core/shell structure, the polyamide forming the core and the polyethylene terephthalate surrounding the polyamide as the shell. The polyethylene terephthalates have advantageously been modified by isophthalic acid and by alkali metal salts of sulfoisophthalic acid. The bico pellets can be subjected to a solid phase condensation (200-240° C., 10-14 h) in the further processing. Under this thermal stress, the polyamide compositions described in the literature form gels as a result of formation of xylylenetriamine or exhibit a high viscosity increase. As a result of the gels and the viscosity increase of the polyamide compositions during processing, the bico pellets made from the available polyamide compositions known to date are less suitable for further processing to transparent films and containers, particularly bottles.

The polyamide compositions described in this invention solve this problem. Owing to the high stability of the polyamide compositions during the processing operation, bico pellets are obtained from which highly transparent, gel-free bottles are produced.

### EXAMPLES

### End Groups

### AEG=Amino End Group Content, CEG=Acid End Group Content

As usual, the aforementioned concentrations are defined as the number of end groups (in moles or equivalents) per mass unit of polyamide, for example x mmol of end groups per kg of polyamide.

The determination of the amino end groups can be carried out, for example, by means of titration of a solution of the polyamide in the presence of an indicator. To this end, the polyamide is dissolved in a mixture of phenol and methanol (e.g. 75% by weight of phenol and 25% by weight of methanol) with heating. For example, the mixture can be kept under reflux at the boiling point until the polymer has dissolved. The cooled solution is admixed with a suitable indicator or an indicator mixture (for example methanolic solution of benzyl orange and methylene blue) and titrated with a methanolic perchloric acid solution in glycol up to the color change. The amino end group concentration is calculated from the perchloric acid consumption.

Alternatively, the titration can also be carried out potentiometrically with a perchloric acid solution in ethylene glycol without indicator, as described in WO 02/26865 on page 11.

The determination of the carboxyl end groups can be undertaken, for example, likewise by titration of a solution of the polyamide using an indicator. To this end, the polyamide is dissolved in benzyl alcohol (phenylmethanol) with heating, for example to boiling, a riser tube being attached and nitrogen gas being introduced. The still-hot solution is admixed with a suitable indicator (for example propanolic solution of cresol red) and titrated immediately with an alcoholic potassium hydroxide solution (KOH dissolved in a mixture of methanol, 1-propanol and 1-hexanol) up to the color change. The carboxyl end group concentration is calculated from the KOH consumption.

Alternatively, the titration can also be carried out conductometrically with an NaOH solution in benzyl alcohol without indicator, as described in WO 02/26865 on page 11-12.

### Relative Viscosity RV

The relative viscosity of the polyamide was carried out with samples of 1 g of polyamide in 100 ml of 96% by weight sulfuric acid and the measurement with the aid of a 50120 Ubbelohde viscometer 2 (from Schott) to DIN EN ISO 1628-1.

### Intrinsic Viscosity IV

The intrinsic viscosity of the slightly crystalline polyethylene terephthalates with a mean molecular weight was determined by dissolving 0.1 g of polymer (ground pellet) in 25 ml of a 60/40 mixture of phenol and tetrachloroethane. The viscosity of this solution was determined at 30° C. with an Ubbelohde 1B viscometer. The intrinsic viscosity was calculated via the relative viscosity with the aid of the Billmeyer equation. To determine the intrinsic viscosity of high molecular weight or highly crystalline polyethylene terephthalates which are not soluble in the 60/40 solvent mixture, 0.1 g of polymer (ground pellet) is dissolved in 25 ml of a 50/50 mixture of trifluoroacetic acid and dichloromethane. The viscosity of this solution was determined at 30° C. with an Ubbelohde OC viscometer. The intrinsic viscosity was calculated with the aid of the Billmeyer equation and regression analysis (in relation to the 60/40 phenol/tetrachloro-ethane mixture). The regression calculation is:

I.V.(60/40 phenol/tetrachloroethane)=0.8229×IV(50/50 trifluoracetic acid/dichloro-methane)+0.0124

### Triamine (Xylylenetriamine) Content

After dissociation of the sample matrix, the triamine is analyzed by means of capillary electrophoresis and UV detection. The quantification is effected by the internal standard method. The internal standard used is N-methylimidazole. To prepare the sample, approx. 200 mg of pellet are dissociated with 15 ml of 1N H₂SO₄ at 180 degrees C. for 4 h in an autoclave. 0.5 ml of the dissociation solution is admixed with 1 ml of int. standard solution, then the sulfate is precipitated with Ba(OH)₂ solution and adjusted to 50 ml with water. Aliquots of these solutions are subjected to electrophoresis. For electrophoresis, a CE compact system from Biofocus, capillaries (fused silica, uncoated) and an electronic integrator are used.

Electrophoresis conditions: capillary: fused silica, uncoated; total length 40 cm; separation length 35.5 cm; internal diameter 75 μm; cathode electrolyte: 20 mM NaH2PO₄ (pH 2.5 adjusted with H₃PO₄); anode electrolyte: 20 mM NaH2PO₄ (pH 2.5 adjusted with H₃PO₄); separation voltage: +15 kV/+375 V/cm Temperature: 25° C.; detection: UV/A=200 nm; sample injection: 5 psi*s

### Melt Viscosity

The melt viscosities were determined with the aid of a deformation-controlled rheometer (rotational rheometer) from TA—Instruments (ARES). Before the measurement, the polyamide sample was dried in a standard manner at 80° C. in a vacuum oven for >3 d (days). The sample, directly out of the vacuum oven, is placed onto the preheated lower plate of the rheometer, and its heating oven was closed. The upper plate was then moved downward until the measurement gap of 1 mm had been attained. The melting time of 5 min starts from here. The supernatant sample between the two plates is stripped off with a spatula. After these 5 min of melting time, the measurement begins and proceeds over a period of 70 min. Measurement conditions: measurement geometry: plate-plate Ø 25 mm; measurement gap: 1 mm; melting time: 5 minutes; deformation: 30%.

### Solid Phase Condensation Test

To determine ΔRV, the polyamide samples are subjected to a solid phase condensation at 230° C. for 14 h. To this end, 10 g of the polyamide pellet are introduced into an annealing tube and this is placed into an oil bath heated to 230° C. In the annealing tube, the pellet is under a nitrogen flow of 10 l/h.

### Haze Measurement

The measurements were effected through the side walls of the bottles. A HunterLab Color QUEST Sphere Spectrophotometer System equipped with an IBM PS/2 Model 50Z computer, IBM Proprinter II printer, various holders for the specimens and green, gray and white calibration plates were used. The HunterLab Spectrocolorimeter is an instrument for determining color and appearance. Light from the lamp is scattered at a circular orifice and either conducted through an object to a lens or reflected on an object to a lens. The lens collects the light and conducts it to a diffraction grating which divides the light into its individual wavelength ranges. The dispersed light is passed onto an array of silicon diodes. Signals from the diodes pass through an amplifier into a converter and are processed to data. The haze values are made available by the software. The ratio is calculated from the transmission of the scattered light to the total light transmission. Multiplication by 100 affords the haze value (0% represents transparent material, 100% an opaque material). The samples, which have to be prepared either for transmission or reflection measurement, must be clean and free of all types of scratches or damage. In the case of transmission, the size of the sample must be adjusted to the size of the circular orifice. Each sample is analyzed at four different points. To measure the thickness of the bottle walls, a Panametrics Magna-Mike 8000 Hall Effect Thickness Gauge was used.

### Example 1

A stirred 10 l autoclave (pear-shaped tank with bottom valve) is charged at room temperature under a nitrogen stream (approx. 101/h) with 2121.4 g (14.52 mol, corresponds to an adipic acid excess of 100 mmol/kg of adipic acid) of adipic acid, 1929.6 g (14.17 mol) of meta-xylylenediamine and 1714.3 g of water. As a result of the exothermic reaction of the salt formation, the internal temperature rises to 90° C. With stirring (80 rpm), the mixture is heated up to 136° C. with the tank closed within a period of 60 min. At a pressure of 2 bar, water is then distilled off within 75 min until an approx. 90% mixture is obtained. The tank is closed again and, with further heating, on attainment of a temperature of 170° C. at 4 bar, the remaining water is distilled off within 50 min. Subsequently, the tank is decompressed to atmospheric pressure within 20 min, in the course of which the temperature rises to 249° C. On attainment of atmospheric pressure, postcondensation is effected under a nitrogen stream for 20 min; the temperature rises to 262° C. After a further 10 minutes of postcondensation under reduced pressure (1000-200 mbar), the polyamide is discharged through the bottom valve, passes through a water bath as an extrudate and is granulated. Subsequently, drying was effected at 105° C. until a residual moisture content of below 250 ppm had been attained. 3350 g of pellet were obtained. After drying, a relative viscosity of 1.601, an amino end group content of 10 mmol/kg and an acid end group content of 221 mmol/kg were measured.

### Example 2

The condensation was carried out by the process described in example 1. The starting mixture used was 2101.0 g (14.38 mol, corresponds to an adipic acid excess of 60 mmol/kg of adipic acid) of adipic acid, 1929.6 g (14.17 mol) of meta-xylylenediamine and 1714.3 g of water.

3200 g of pellet were obtained. After discharge, a relative viscosity of 1.913, an amino end group content of 17 mmol/kg and an acid group content of 138 mmol/kg were measured. A solid phase condensation in a tumbler at 185° C. with nitrogen flow raised the relative viscosity to 1.990 after 8 h at an amino end group content of 9 mmol/kg and an acid end group content of 133 mmol/kg.

### Example 3

The condensation was carried out by the process described in example 1. The starting mixture used was 2111.2 g (14.45 mol, corresponds to an adipic acid excess of 80 mmol/kg of adipic acid) of adipic acid, 1929.6 g (14.17 mol) of meta-xylylenediamine and 1714.3 g of water. Decompression of the tank to atmospheric pressure was followed by postcondensation under a nitrogen stream for 30 min, then under reduced pressure (1000-200 mbar) for a further 15 min, then by discharge and granulation.

3310 g of pellet were obtained. Before drying, a relative viscosity of 1.703, an amino end group content of 11 mmol/kg and an acid end group content of 200 mmol/kg were obtained. After drying a relative viscosity of 1.721, an amino end group content of 11 mmol/kg and an acid end group content of 197 mmol/kg were obtained.

### Example 4

The condensation was carried out by the process described in example 1. The starting mixture used was 2111.2 g (14.45 mol, corresponds to an adipic acid excess of 80 mmol/kg of adipic acid) of adipic acid, 1929.6 g (14.17 mol) of meta-xylylenediamine and 1714.3 g of water. Decompression of the tank to atmospheric pressure was followed by postcondensation under a nitrogen stream for 30 min, then under reduced pressure (1000-200 mbar) for a further 5 min, then by discharge and granulation.

3380 g of pellet were obtained. After discharge, a relative viscosity of 1.790, an amino end group content of 14 mmol/kg and an acid end group content of 183 mmol/kg were measured. After drying a relative viscosity of 1.779, an amino end group content of 10 mmol/kg and an acid end group content of 180 mmol/kg were obtained.

### Comparative Example 1a and b

WO-A-00/22043 describes, in the example, the preparation of an acid-terminated polyamide from a 60% by weight salt solution of adipic acid and meta-xylylenediamine. For comparison, the example was reproduced exactly in accordance with the method specified, but the batch size had to be halved because the reaction vessel specified in WO-A-00/222043 is too small for the batch specified! A mixture of 105 g of water and 89.4 g (0.612 mol, 2 mol % excess) of adipic acid were introduced into a 500 ml flask, then flushed with nitrogen for 30 min. 81.7 g (0.599 mol) of meta-xylylenediamine were added rapidly. The flask was equipped with a nitrogen attachment, a metal stirrer and a distillation head with short condenser. The flask was then placed into a metal/oil bath preheated to 110° C. for 30 minutes. Within 60 minutes, the temperature was raised stepwise to 275° C. and a slightly viscous, clear polyamide was obtained.
The inherent viscosity was IV=0.42 (0.458), the relative viscosity RV=1.52, the amino end group content AEG=28 mmol/kg (10 mmol/kg) and the acid end group content CEG=305 mmol/kg (220 mmol/kg).
(The values in brackets are those reported in WO 0022043)
   a) The method was repeated exactly once again.
The inherent viscosity was IV=0.38 (0.458), the relative viscosity RV=1.47, the amino end group content AEG=49 mmol/kg (10 mmol/kg) and the acid end group CEG=318 mmol/kg (220 mmol/kg).

The polyamides prepared were analyzed for their triamine content. The inventive polyamide compositions prepared by the batchwise process feature a triamine content of less than 0.15% by weight.

Moreover, the polyamides prepared were analyzed for their residual monomer content of adipic acid. The inventive polyamide compositions prepared by the batchwise process, before the extraction, feature a residual content of adipic acid of less than 500 ppm.

The stability in the melt was analyzed by rotational rheology measurements. The evolution of the melt viscosity as a function of time was determined. The parameter laid down for the melt stability was the quotient of the melt viscosity after 60 min and the melt viscosity after 5 min.

The inventive polyamide compositions feature a very high stability and are therefore notable for very low values of the quotient η₆₀ₘᵢₙ/η₅ₘᵢₙ; the values are below 1.5.

The stability during solid phase condensations (solid state polycondensation=SSP) was measured by determining the relative viscosities before and after the solid phase condensation. The solid phase condensations were carried out under a nitrogen stream at 230° C. for 14 h. The parameter laid down for the stability was the relative viscosity difference ΔRV=RV_{before SSP}−RV_{after SSP}. The inventive polyamides are notable for a relative viscosity difference of less than 0.4.

The results are compiled in table 1.

TABLE 1

| | | | | Triamine | Residual AA | | |
|---|---|---|---|---|---|---|---|
| | RV | AEG | CEG | content | content | η_{60 min}/η_{5 min} | ΔRV |
| EXAMPLE 1 | 1.600 | 9 | 228 | 0.11% | 400 ppm | 1.38 | 0.19 |
| EXAMPLE 2 | 1.989 | 9 | 133 | 0.09% | 180 ppm | 1.38 | 0.39 |
| EXAMPLE 3 | 1.721 | 11 | 197 | 0.13% | 340 ppm | 1.27 | 0.22 |
| EXAMPLE 4 | 1.779 | 10 | 180 | 0.13% | 300 ppm | 1.30 | 0.27 |
| Comp. ex. 1a | 1.52 | 28 | 305 | 0.16% | 1200 ppm | 2.34 | 0.31 |
| Comp. ex. 1b | 1.47 | 49 | 318 | 0.16% | 3100 ppm | 2.43X | 0.35 |
| MXD6007* | 2.550 | 20 | 65 | 0.10% | 30 ppm | 3.5 | 0.71 |

All values in the table were determined after the drying or solid phase condensation. (*According to the patents EP-A-0084661, EP-A-007100 and US-B-6,303,741, for example, the MXD6007 is prepared in a melt process and not via a homogeneous salt solution)

Table 1 summarizes the most important results in relation to the synthesis. EXAMPLE 1-4 are the inventive polyamide compositions in which the relative viscosity, the end groups and also the process conditions were varied. MXD6007, commercially available from Mitsubishi Gas Chemical, was used as a further comparative example. Unlike the inventive polyamide compositions, all three comparative examples do not simultaneously fulfill all criteria: AEG less than 15, triamine content less than 0.15, η₆₀ₘᵢₙ/η₅ₘᵢₙ<1.5 and ΔRV<0.4.

### Example 5

A homogeneous aqueous solution consisting of 103.0 kg (704.76 mol, corresponds to an adipic acid excess of 110 mmol/kg) of adipic acid and 93.4 kg (685.81 mol) of meta-xylylenediamine and 193.2 kg of water was conveyed from a heated stock vessel at approx. 90° C. at a rate corresponding to an amount of polyamide of 5 kg/hour by means of a metering pump into a vertical tubular evaporator. The evaporator was heated with a heat transfer medium which was at a temperature of 275° C. The evaporator had a length of 4500 mm and a capacity of 5000 ml and a heat transfer surface area of about 0.5 m². The residence time in the evaporator was approx. 60 sec. The mixture of prepolymers and steam leaving the evaporator was at a temperature of 255° C. and was separated into steam and melt in a separator. The melt resided in the separator for another 5 min and was then conveyed by means of a discharge/venting extruder into an underwater sphere granulation. The separator and the evaporator zone were kept under a pressure of 5 bar by means of a pressure-retaining device which was disposed downstream of the column. The steam removed in the separator was conducted into a column with random packing and approx. 10 theoretical plates, into which approx. 1.5 l of vapor condensate were introduced per hour at the top to generate reflux. At the top of the column, a temperature of 155° C. was established. The steam leaving downstream of the decompression valve was condensed and had a content of meta-xylylenediamine of less than 0.05% by weight. The column bottoms obtained were an aqueous solution of meta-xylylenediamine. Before entry into the evaporator, this solution was again added to the starting salt solution by means of a pump.

Downstream of the evaporator, the prepolymer had a relative viscosity of 1.0-1.1, measured in 98% by weight sulfuric acid at 25° C., and, after the end group analysis, had a conversion of from 93 to 95%. The content of xylylenetriamine was from 0.20 to 0.24% by weight based on the polyamide. After granulation, the polyamide had a very light intrinsic color and a relative viscosity of from 1.50 to 1.55. The amino end group content was 42 mmol/kg, the acid end group content 235 mmol/kg. In the discharge extruder, the melt was decompressed to standard pressure and subjected to virtually no further condensation at a residence time of less than 1 min. The polymer converted to granule form is subsequently extracted with water in a countercurrent unit at 90-105° C. under the customary conditions. Thereafter, the resulting pellet was annealed to a relative end viscosity of 1.68 by a solid phase condensation at a temperature of 160° C. for 30 h. After heat treatment, the amino end group content was 13 mmol/kg, the acid end group content 203 mmol/kg and the triamine content 0.14% by weight.

The results are compiled in table 2.

TABLE 2

| | RV** | AEG** | CEG** | Triamine content | ΔRV |
|---|---|---|---|---|---|
| EXAMPLE 5 | 1.672 | 10 | 203 | 0.14% | 0.21 |

(**Values after solid phase condensation)

The extremely good dispersibility of the inventive polyamides in modified polyethylene terephthalates is manifested in low haze values which were measured on bottles which were produced from these mixtures.

To this end, pellet mixtures of 2-10% polyamide and 90-98% polyethylene terephthalates were produced.

These pellet mixtures were processed on a 420 C injection-molding machine from Arburg to bottle preforms with a weight of 28 g. With the aid of a Sidel SB01 blow-molding machine, the preforms were used to blow-mold bottles having a volume of 660 ml at approx. 100° C. at a pressure of 40 bar.

The haze measurements were undertaken on these bottles.

Table 3 reproduces the results of the experimental series with pellet mixtures.

TABLE 3

| | MXD6007 | EXAMPLE 1 | EXAMPLE 2 |
|---|---|---|---|
| Polyamide content | 5 | 5 | 5 |
| [% by wt.] | | | |
| RV | 2.55 | 1.600 | 1.989 |
| AEG [mmol/kg] | 20 | 228 | 133 |
| CEG [mmol/kg] | 65 | 9 | 9 |
| Polyamide content | 95 | 95 | 95 |
| [% by wt.] | | | |
| TPA [mol %] | 84.2 | 84.2 | 84.2 |
| IPA [mol %] | 1.2 | 1.2 | 1.2 |
| LiSIPA [mol %] | 0.5 | 0.5 | 0.5 |
| Stretched bottle wall | | | |
| Stretching ratio (long side) | 3.09 | 3.09 | 3.09 |
| Thickness [mm] | 0.35 | 0.35 | 0.35 |
| Haze [%] | 6.6 | 5.4 | 5.2 |

For explanation:
TPA = molar fraction in % of terephthalic acid in the acid fraction of the polyethylene terephthalate
IPA = molar fraction in % of isophthalic acid in the acid fraction of the polyethylene terephthalate
LiSIPA = molar fraction in % of the Li salt of sulfoisophthalic acid in the acid fraction of the polyethylene terephthalate

The identical experimental series were also carried out with the inventive polyamide compositions which have been prepared in the continuous process.

Table 4 summarizes the results.

TABLE 4

| | MXD6007 | Example 5 |
|---|---|---|
| Polyamide content | 5 | 5 |
| [% by wt.] | | |
| RV | 2.55 | 1.672 |
| AEG [mmol/kg] | 20 | 203 |
| CEG [mmol/kg] | 65 | 10 |
| Polyamide content | 95 | 95 |
| [% by wt.] | | |
| TPA [mol %] | 84.2 | 84.2 |
| IPA [mol %] | 1.2 | 1.2 |
| LiSIPA [mol %] | 0.5 | 0.5 |
| Stretched bottle wall | | |
| Stretching ratio (long side) | 3.09 | 3.09 |
| Thickness [mm] | 0.35 | 0.35 |
| Haze [%] | 6.6 | 4.85 |

In addition, haze measurements were also undertaken on bottles which had been produced from bicomponent pellets having a core/shell structure.

The bicomponent pellets (core: polyamide, shell: polyethylene terephthalate) were produced by a coextrusion process. To this end, a Haake single-screw extruder was used for the polyamide and a Killion single-screw extruder for the polyethylene terephthalate. The intrinsic viscosity of the polyethylene terephthalate before the coextrusion was I.V.=0.54-0.56 dl/g. The processing temperature was 270-280° C. The resulting bicomponent pellets were subsequently subjected to a solid phase condensation at 210-215° C. with nitrogen flow for 12 hours. To this end, a reactor from Karl Kurt Juchheim Laborgeräte was used. After the solid phase condensation, intrinsic viscosities of I.V.=0.81-0.83 dl/g were measured.

After the solid phase condensation, the bicomponent pellets were processed to bottle preforms with a weight of 49 g with the aid of an Arburg 320 injection-molding machine. These preforms were then used afterward to blow-mold the corresponding bottles with a volume of 1.5 l with a Sidel SB01 blow-molding machine at approx. 100° C. and a pressure of 40 bar.

Table 5 summarizes the results.

TABLE 5

| | | EXAMPLE | EXAMPLE | EXAMPLE |
|---|---|---|---|---|
| | MXD6007 | 1 | 2 | 5 |
| Polyamide | 5 | 5 | 5 | 5 |
| content | | | | |
| [% by wt.] | | | | |
| RV | 2.55 | 1.600 | 1.989 | 1.672 |
| AEG [mmol/kg] | 20 | 228 | 133 | 203 |
| CEG [mmol/kg] | 65 | 9 | 9 | 10 |
| Polyamide | 95 | 95 | 95 | 95 |
| content | | | | |
| [% by wt.] | | | | |
| TPA [mol %] | 84.2 | 84.2 | 84.2 | 84.2 |
| IPA [mol %] | 1.2 | 1.2 | 1.2 | 1.2 |
| LiSIPA [mol %] | 0.5 | 0.5 | 0.5 | 0.5 |
| Stretched bottle | | | | |
| wall | | | | |
| Stretching ratio | 2.7 | 2.7 | 2.7 | 2.7 |
| (long side) | | | | |
| Thickness [mm] | 0.32 | 0.32 | 0.32 | 0.32 |
| Haze [%] | 13.1 | 3.47 | 5.27 | 3.20 |

1. A polyamide composed of meta-xylylenediamine and adipic acid, wherein the amino end group content is less than 15 mmol/kg, the relative viscosity is from 1.55 to 2.0 and the content of triamine in the polyamide is less than or equal to 0.3 mol %.

2. The polyamide composed of meta-xylylenediamine and adipic acid according to claim 1, wherein the content of triamine in the polyamide is less than or equal to 0.15 mol %.

3. A process for preparing polyamides according to claim 1, wherein salt solutions of adipic acid and m-xylylenediamine are reacted in a molar ratio of 1.5:1 to 1.001:1 at temperatures of from 80 to 300° C. and a pressure of from 1 to 20 bar with removal of water.

4. The polyamide composed of meta-xylylenediamine and adipic acid according to claims 1, prepared by reacting salt solutions of adipic acid and m-xylylenediamine in a molar ratio of 1.5:1 to 1.001:1 at temperatures of from 80 to 300° C. and a pressure of from 1 to 20 bar with removal of water.

5. A process for preparing polyamides according to claim 2, wherein salt solutions of adipic acid and m-xylylenediamine are reacted in a molar ratio of 1.5:1 to 1.001:1 at temperatures of from 80 to 300° C. and a pressure of from 1 to 20 bar with removal of water.

6. The polyamide composed of meta-xylylenediamine and adipic acid according to claim 2, prepared by reacting salt solutions of adipic acid and m-xylylenediamine in a molar ratio of 1.5:1 to 1.001:1 at temperatures of from 80 to 300° C. and a pressure of from 1 to 20 bar with removal of water.

7. The polyamide according to claim 1, wherein the relative viscosity is from 1.60 to 1.9.

8. The polyamide according to claim 1, wherein the relative viscosity is from 1.65 to 1.75.

9. The process according to claim 3, wherein salt solutions of adipic acid and m-xylylenediamine are reacted in a molar ratio of from 1.1:1 to 1.007:1 at a temperature from 120 to 270° C. and a pressure of from 2 to 7 bar.

10. The polyamide according to claim 4, wherein the polyamide is prepared by reacting salt solutions of adipic acid and m-xylylenediamine in a molar ration of from 1.1:1 to 1.007:1 at a temperature from 120 to 270° C. and a pressure of from 2 to 7 bar.

11. The polyamide according to claim 1, wherein the polyamide contains from 1 to 150 ppm residual adipic acid monomer.

12. The polyamide according to claim 1, wherein the polyamide contains less than 10 ppm meta-xylylenediamine monomer.
